(19) United States
(12) Patent Application Publication
(10) Pub. No.: US 2005/0279761 A1
(43) Pub. Date: Dec. 22, 2005

(54) Hermetically sealed container with drop control

(76) Inventors: Gerhard H. Weiler, Woodstock, IL (US); Kathleen E. Kurek, Des Plaines, IL (US)

Correspondence Address: OLSON & HIERL, LTD., 36th Floor, 20 North Wacker Drive, Chicago, IL, 60606, US

(21) Appl. No.: 10/869,059

(22) Filed: Jun. 16, 2004

(51) Int. Cl. B67D 5/00

(52) U.S. Cl. 222/83

(57) ABSTRACT

A hermetically sealed container for liquid contents occluded by a pierceable top and a separate dispensing cap threaded over the container and including a spike that defines a through passageway which terminates in a dispensing nozzle at one end and a pointed piercing tip at the other end. The piercing tip defines a pair of spaced apertures for dispensing drops of uniform, repeatable, and controllable size through the dispensing nozzle.

### TECHNICAL FIELD OF THE INVENTION

This invention relates to a hermetically sealed container and, more particularly, to such a container provided with a dispensing cap with a drop control spike.

### BACKGROUND OF THE INVENTION

Hermetically sealed containers typically have a body portion, a neck portion, a nozzle, and a closure portion for closing and sealing the nozzle opening. It is also known to provide these containers with means for permitting the same to be unsealed and opened by piercing a membrane occluding the nozzle opening. To facilitate the opening of such a container, the closure may be provided with a spike which pierces the membrane.

Containers incorporating the above-described membrane structure are usually formed from a thermoplastic molding material such as polyethylene (low or high density), polypropylene, or like materials compatible with the contents of the container. Such containers are conventionally fabricated by blow molding or vacuum forming in split mold parts that close along a parting plane.

The membrane can be formed by conventional techniques during the container molding process and comprises a region of such containers where the thermoplastic material is of reduced thickness so that it can later be pierced. Of course, before the membrane is molded onto the top closure, the container is filled with the desired contents from a filling tube.

The above-described hermetically sealed, thermoplastic container is used to package a variety of materials. Such containers have been found to be especially suitable for use in dispensing sterile fluids, such as pharmaceutical solutions and ointments. While these conventional containers function satisfactorily for the purposes for which they have been designed, it would be desirable if the advantages offered by such hermetically sealed containers could be employed in other applications. Specifically, it would be beneficial to be able to use such a container for dispensing drops of fluid of uniformly repeatable size. This would assure the consistent dispensing of a measured quantity of a pharmaceutical solution, for example.

However, the use of such containers for dispensing drops has not been altogether satisfactory. When the membrane is pierced, the exposed dispensing orifice or aperture on the container may be surrounded by a relatively rough, uneven, or jagged region which defines the surface of the broken membrane. Such uneven orifices may interfere with the formation of uniformly repeatable drops for a given container, and may contribute to a variation in drop size from one container to another depending on the vagaries of the broken membrane. Furthermore, the geometry of the neck of the container adjacent the drop-dispensing orifice or aperture may not be conductive to the formation of stable, controllable drops of predictable and repeatable size.

It would be desirable to provide an improved hermetically sealed container with the convenience of a separate dispensing cap that includes a unitary drop-dispensing spike for reliable and repeatable dispensing of drops of predictable and uniform size.

The present invention provides the aforementioned desirable benefits and features.

### SUMMARY OF THE INVENTION

The present invention relates to a unitary, hermetically sealed container of a thermoplastic material and parts of a hermetically sealed container which are suitable and adapted for the dropwise dispensing of a liquid contained therein.

The container includes a hollow container body defining a liquid enclosure, an externally threaded neck portion unitary with the container body, and a bulbous hollow top portion unitary with the neck portion. The neck portion defines a through passageway for contents of the container body. The through passageway is occluded by a pierceable top. Counterteeth are provided on the neck portion at the base or juncture thereof with the container body.

The container carries a dispensing cap on the top portion. The dispensing cap has a hollow shell with an externally threaded head portion terminating in a dome and an internally threaded skirt portion unitary with the head portion. Detents on the inner surface of the skirt portion engage with the counterteeth. The dispensing cap also includes a penetrating spike which is unitary with the dome and defines a through passageway. The spike terminates at one end in an external dispensing nozzle and in an internal, pointed piercing tip at the end opposite said one end. The pointed piercing tip defines a pair of spaced apertures in communication with the through passageway.

An overcap with a skirt portion provided with interior threads is threadedly secured to and over the head portion of the dispensing cap.

The apertures in the tip of the spike are spaced from one another, usually disposed opposite to one another. Preferably, the apertures are generally crescent moon-shaped.

The dome of the overcap includes an inner surface having a pilot protruding therefrom and sized to occlude the nozzle defined in the dome of the dispensing cap.

The spike pierces the container top portion when the dispensing cap is fully and irreversibly threaded over the neck of the container. To dispense a liquid drop from the container, the container is inverted and liquid flows successively through the container top portion, the apertures in the spike, the spike passageway and out through the nozzle defined on the dispensing cap in a controlled manner. The apertures are of uniform even size and configured to allow the formation of liquid drops of uniform, controllable, and repeatable size.

There are other advantages and features of the present invention which will be more readily apparent from the following detailed description of the preferred embodiment of the invention, the accompanying drawings, and the appended claims.

### BRIEF DESCRIPTION OF THE DRAWINGS

In the drawings,

FIG. 1 is a partially broken front elevational view of the top of the container of the present invention together with a vertical cross-sectional view of the dispensing drop-control cap therefor in its partially threaded placement over the neck portion and nozzle of the container;

FIG. 2 is a view similar to FIG. 1 except that the dispensing cap is shown therein in its fully threaded piercing position over the neck and nozzle of the container and further depicting an overcap shown in vertical cross-section and threaded over the top of the dispensing cap;

FIG. 3 is a horizontal cross-sectional view taken along the plane 3-3 in FIG. 2;

FIG. 4 is a plan view of the interior of the dispensing cap of the present invention;

FIG. 5 is a vertical cross-sectional view of the dispensing cap taken along the plane 5-5 in FIG. 4; and

FIG. 6 is an enlarged plan view of the interior spike region of the dispensing cap of the present invention.

### DETAILED DESCRIPTION OF THE PREFERRED EMBODIMENT

The invention disclosed herein is, of course, susceptible of embodiment in many different forms. Shown in the drawings and described below in detail is a preferred embodiment of the invention. It is to be understood, however, that the present disclosure is an exemplification of the principles of the invention and does not limit the invention to the illustrated embodiment.

The precise shapes and sizes of the components described herein are not necessarily essential to the invention since the invention is described with reference to an illustrative embodiment only.

For ease of description, the container of the invention will be described in a normal (upright) operating position and terms such as upper, lower, horizontal, etc., will be used with reference to this position. It will be understood, however, that the container may be manufactured, stored, transported, used, and sold in an orientation other than the position described.

The container of this invention may be fabricated and assembled with conventional molding apparatus and other mechanisms, the details of which, although not fully illustrated or described, will be apparent to those having skill in the art and an understanding of the necessary functions of such apparatus and mechanisms. The detailed descriptions of such apparatus or other mechanisms are not necessary to an understanding of the invention and are not herein presented because such apparatus and other mechanisms form no part of the present invention.

A thermoplastic container embodying the present invention can be initially molded and filled as a unitary, hermetically sealed structure generally utilizing, for example, the technique and apparatus described U.S. Pat. No. 4,671,763 to Weiler et al. A formed and hermetically sealed container 10 of the present invention is illustrated in FIGS. 1-6. The container 10 is preferably fabricated from conventional thermoplastic molding materials such as polyethylene, low or high density polypropylene, and the like materials compatible with the container contents. Preferably, container 10 is formed by molding an extruded parison within a hollow mold. The cap and overcap are usually molded from high impact styrene, acrylonitrile-butadiene-styrene, and the like.

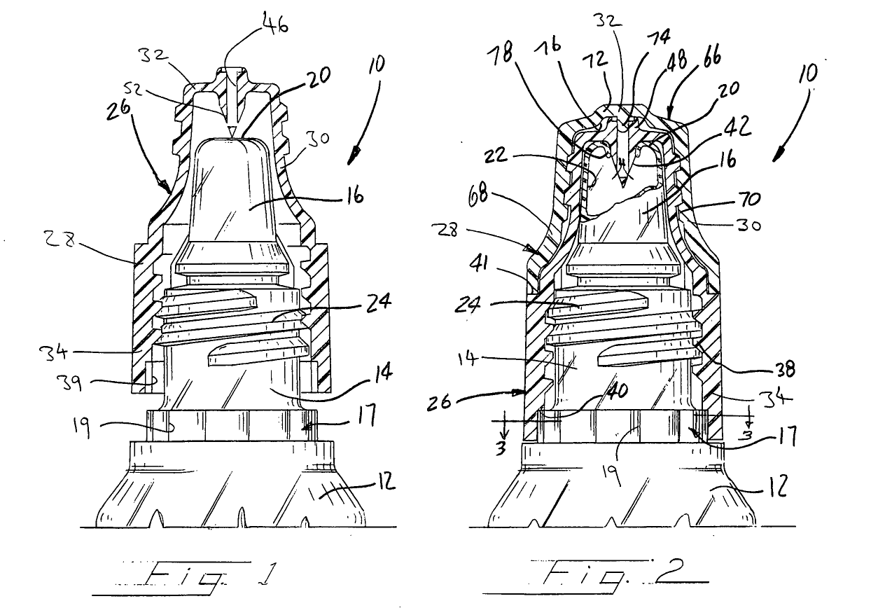

The teachings of the present invention find application in the production of filled and unfilled containers having a wide variety of shapes and sizes. Referring to FIG. 1, container 10 is an example of one such container and includes a hollow container body 12 including a neck portion 14 having a top portion 16 defining a pierceable top 20. This is a region of the container 10 wherein the material comprising the same is of reduced thickness so that the top 20 can be pierced to gain access to container contents. A base 17 at the junction of the container body 12 and the container neck portion 14 is provided with counterteeth 19 for ratchet-like engagement with dispensing cap 26 (FIG. 2). The interiors of the neck portion 14 and top portion 16 together define an open, axial, through liquid passageway 22 (FIG. 2) in communication with the interior of the container body 12 at one end and the opening in the top portion 16 at the other end. Neck portion 14 additionally defines an exterior threaded outer surface 24.

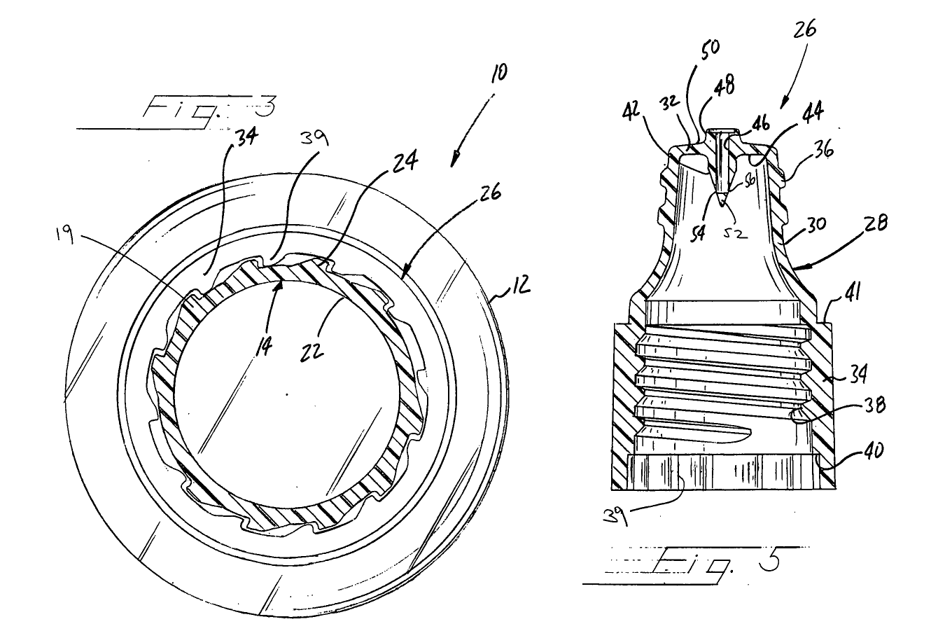

Referring to FIGS. 1, 2 and 5, container 10 additionally comprises a dispensing cap 26 which includes a hollow, generally bell-shaped shell 28 having a head portion 30 terminating in a unitary dome 32 and a skirt portion 34 depending unitarily downwardly from a lower peripheral edge of the head portion 30. Head portion 30 defines a threaded exterior or outer surface 36 while skirt portion 34 defines a threaded interior or internal surface 38 with detents 39 for engaging counterteeth 19 (FIG. 3). Head portion 30 additionally defines a lower circumferential interior shoulder 40 and an upper circumferential exterior shoulder 41. Head portion 30 preferably has a double lead thread.

In accordance with the present invention, a penetrating generally cylindrical spike 42 that terminates in conical tip 52 and is unitary with and depends generally vertically downwardly from the interior face 44 of the dome 32 of cap 26. Spike 42, which defines an interior, hollow through liquid passageway 46, terminates at one end in an external dispensing nozzle 48 which protrudes outwardly from the exterior face 50 of the dome 32. At the end thereof opposite the end defining the nozzle 48, spike 42 terminates in a pointed piercing tip 52. A pair of spaced and diametrically opposed elongate apertures 54 and 56 are defined by and extend through the tip 52 to provide fluid flow communication with the through passageway 46 defined in the interior of the spike 42.

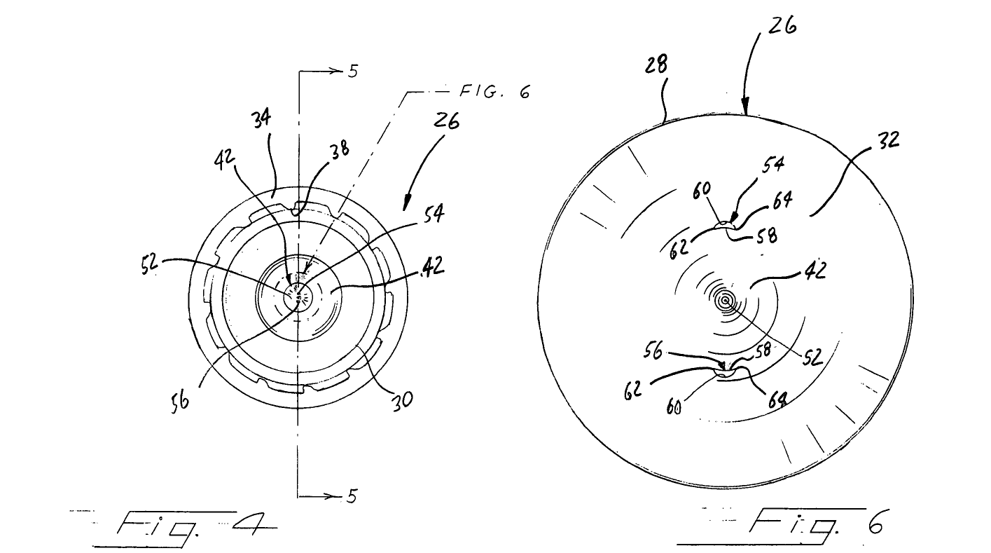

As more particularly shown in FIG. 6, each of the apertures 54 and 56 is generally crescent moon-shaped and is defined by a first generally arcuate convex wall or face 58 which bulges outwardly away from the longitudinal centerline of the tip 52 of the spike 42 and a second generally arcuate concave wall or face 60 which is located aft of the first wall 58 so as to define a pair of opposed aperture edges 62 and 64. Second wall 60 arcs or curves a greater amount than the first wall 58. Each of the apertures 54 and 56 is positioned on the tip 52 of spike 42 in an orientation generally normal to the longitudinal centerline or axis of spike 42 with the edges 62 and 64 thereof spaced from and on opposite sides of such longitudinal axis. Preferably, the apertures 54 and 56 are located at least one spike diameter away from the inner surface of the dome 32 of the dispensing cap 26.

As shown in FIG. 2, container 10 when fully assembled also includes a generally bell-shaped overcap 66 with a skirt portion 68 having a threaded interior surface 70 and a unitary dome 72. A pilot or plug 74 extends downwardly from the interior face 76 of the dome 72 and engages and occludes dispensing nozzle 48.

To dispense the contents of the container 10, dispensing cap 26 is initially placed over and threaded onto the top portion 16 and neck portion 14 of container 10 as shown in FIG. 1 and then subsequently fully and irreversibly threaded into the position shown in FIG. 2 so that the lower shoulder 40 of cap 26 is abutted against the top of the base 17 of neck portion 14 and detents 39 have engaged with counterteeth 19. The spike 42 has pierced through the membrane 20 on the top portion 16 and protrudes into the passageway 22 defined by the interior of top portion 16 and neck portion 14. Once the cap 26 has been fully threaded over the top portion 16 and top 20 has been pierced, cap 26 is permanently secured to the container 10 and cannot be removed.

As shown in FIG. 2, the penetration of spike 42 through top 20 forms a circumferentially extending broken edge 78 which abuts against the circumferential outer surface of spike 42 to provide a seal between the top portion 16 and cap 26.

Container body 12 can then be inverted which causes the liquid contents therein to flow successively through the passageway 22 defined in the neck portion 14 and top portion 16 of container 10, into and through the apertures 54 and 56 in spike 42 (in the direction of the arrows shown in FIG. 2), through the passageway 46 defined in spike 42 and then out of the container 10 through nozzle 48 in a dropwise manner. The uniform, even, non-jagged, configuration of the spike apertures 54 and 56 and, more particularly, the shape, placement and interrelationship between the arcuate walls 58 and 60 thereof assures and provides for the formation of liquid drops of uniform and reproducible size.

As also shown in FIG. 2, overcap 66 may be threaded over the head portion 30 and dome 32 of dispensing cap 26 in a manner wherein the lower circumferential edge of overcap 66 abuts against the top of the shoulder 41 and the pilot 74 extends into nozzle 48 thereby occluding the nozzle opening and sealing the liquid contents. Unlike dispensing cap 26, overcap 66 is removable from the top of dispensing cap 26 and allows for the repeated dropwise dispensing of the container contents.

The foregoing description and the drawings are intended as illustrative and are not to be taken as limiting. Still other variants and arrangements of parts are possible without departing from the spirit and scope of the present invention and will readily present themselves to those skilled in the art.

1. A dispensing cap which comprises:
a hollow shell having an externally threaded head portion terminating in a dome and an internally threaded skirt portion unitary with the head portion; and
a penetrating spike unitary with the dome and defining a through passageway; the spike terminating at one end in an external dispensing nozzle and in an internal pointed tip at the end opposite said one end; and the pointed tip defining a pair of spaced apertures in communication with the through passageway.

2. The dispensing cap of claim 1 wherein the apertures are disposed on the tip in a diametrically opposed relationship.

3. The dispensing cap of claim 1 wherein each of the apertures is generally crescent moon-shaped.

4. The dispensing cap of claim 1 wherein each of the apertures is defined by a first generally arcuate wall and a second generally arcuate wall spaced from and aft of the first wall and terminating in the first wall.

5. The dispensing cap of claim 4 wherein the respective walls arc in the direction of the pointed tip.

6. The dispensing cap of claim 1 wherein the apertures are generally elongate and are disposed in an orientation generally normal to the longitudinal axis of the spike.

7. A dispensing cap assembly which comprises:
a dispensing cap including:
a hollow shell having an externally threaded head portion terminating in a dome and an internally threaded skirt portion unitary with the head portion;
a penetrating spike unitary with the dome and defining a through passageway; the spike terminating at one end in an external dispensing nozzle and in an internal pointed tip at the end opposite said one end; and the pointed tip defining a pair of spaced apertures in communication with the through passageway; and
an overcap including an interiorly threaded skirt portion threadingly secured to and over the head portion of the dispensing cap.

8. The dispensing cap assembly of claim 7 wherein the skirt portion of the overcap terminates at an upper end thereof into a unitary dome adapted to cover the dome of the dispensing cap.

9. The dispensing cap assembly of claim 8 wherein the dome of the overcap includes an inner surface having a plug protruding outwardly therefrom and adapted to occlude the nozzle defined in the dome of the dispensing cap.

10. A unitary, hermetically sealed container of a thermoplastic material, suitable for dropwise dispensing of a liquid contained therein, and comprising:
a hollow container body defining a liquid enclosure, an externally threaded neck portion unitary with the container body, and a top portion unitary with the neck portion, the neck portion and top portion defining a through passageway occluded by a pierceable top;
a dispensing cap threadingly mounted to the neck portion and including:
a hollow shell having an externally threaded head portion terminating in a dome and an internally threaded skirt portion unitary with the head portion;
a penetrating spike unitary with the dome and defining a through passageway; the spike terminating at one end in an external dispensing nozzle and in an internal pointed tip at the end opposite said one end; and the pointed tip defining a pair of spaced apertures in communication with the through passageway; and
an overcap including an interiorly threaded skirt portion threadedly secured to and over the head portion of the dispensing cap.

11. The container of claim 10 wherein the spaced apertures in the pointed tip are disposed in an opposed relationship to one another.

12. The container of claim 10 wherein each of the apertures is generally crescent moon-shaped.

13. The container of claim 10 wherein each of the apertures is defined by a first generally arcuate wall and a second generally arcuate wall spaced from and aft of the first wall and terminating in the first wall.

14. The container of claim 13 wherein the respective walls arc in the direction of the tip of the spike.

15. The container of claim 10 wherein the skirt portion of the overcap terminates at an upper end thereof into a unitary dome adapted to cover the dome of the dispensing cap.

16. The container of claim 10 wherein the dome of the overcap includes an inner surface having a plug protruding outwardly therefrom and adapted to occlude the nozzle defined in the dome of the dispensing cap.
